(19) United States
(12) Patent Application Publication
(10) Pub. No.: US 2010/0087145 A1
(43) Pub. Date: Apr. 8, 2010

(54) WIRELESS COMMUNICATION DEVICE

(75) Inventor: Kazuhiko IKEDA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/561,467

(22) Filed: Sep. 17, 2009

(30) Foreign Application Priority Data
Oct. 3, 2008 (JP) P2008-258823

(51) Int. Cl. H04B 7/005; H04B 7/00

(52) U.S. Cl. 455/41.2; 455/522

(57) ABSTRACT

A wireless communication device includes: a close proximity communication unit configured to perform close proximity wireless communication with a count part device to receive a command signal sent from the counterpart device and to transmit a response signal to the counterpart device in response to the command signal; a detector configured to detect an amount of a spatial movement of the close proximity communication unit; and a controller configured to control the detector to detect the amount of the spatial movement when the command signal is received by the close proximity communication unit and control the close proximity communication unit to transmit the response signal in a first transmission power when the amount of the spatial movement is below a threshold and in a second transmission power that is larger than the first transmission power when the amount of the spatial movement is above the threshold.

### CROSS REFERENCE TO RELATED APPLICATION(S)

The present disclosure relates to the subject matters contained in Japanese Patent Application No, 2008-259823 filed on Oct. 3, 2008, which are incorporated herein by reference in its entirety.

### FIELD

The present invention relates to a wireless communication device capable of performing close proximity wireless communication with a counterpart device.

### BACKGROUND

A technique capable of performing a wireless non-contact identification, which is called Radio Frequency Identification (RFID), is widely used in various systems such as a system for automated ticket gates used in railway systems, a system managing in-and-out time used in business enterprises and offices, a system for electronic payment services. In RFID system, information is exchanged through non-contact communication between a device called a reader-writer and an information medium called a card or a tag.

When an antenna of a coil-shaped element (which may be referred to as a “loop antenna” or a “loop coil antenna”) built in the reader-writer and an antenna of a coil-shaped element built in the card are opposed to each other to obtain state in which communication is allowed, the reader-writer is capable of writing information into the card and reading information from the card A card function or a reader-writer function supporting RFID has been mounted in part of cellular phones.

It has been pointed out that a dead zone may be caused in accordance with change in distance between the reader-writer and the card by the very near positional relation which is taken between the reader-writer and the card when the reader-writer and the card communicate with each other. As a countermeasure, there has been proposed a technique of temporally changing transmission power of the reader-writer. An example of such technique is disclosed in JP-A-2006-260545.

It is described in the publication JP-A-2006-260545 that disadvantage caused by the dead zone can be reduced when a low frequency of 1 kHz or lower or random noise is superposed an a transmission signal of the reader-writer to thereby change the location of the dead zone dynamically over time.

The technique disclosed in the publication JP-A-2006-260545 is for avoiding disadvantages caused by an occurrence of the dead zone, which may occur even though the positional relation between the reader-writer and the card is originally in a range where communication is allowed. In practice, for example, in a case where the system is used in a ticket gate at a railway station, there may occur a situation that the card cannot be brought sufficiently close to the reader-writer because the user puts the card over the reader-writer while the user is walking. A countermeasure different from that disclosed in the publication JP-A-2006-260545 is requested for solving this problem.

### SUMMARY

According to an aspect of the present invention, there is provided a wireless communication device including: a close proximity communication unit configured to perform close proximity wireless communication with a counterpart device to receive a command signal sent from the counterpart device and to transmit a response signal to the counterpart device in response to the command signal; a detector configured to detect an amount of a spatial movement of the close proximity communication unit; and a controller configured to control the detector to detect the amount of the spatial movement, when the command signal is received by the close proximity communication unit and control the close proximity communication unit to transmit the response signal in a first transmission power when the amount of the spatial movement is below a threshold and in a second transmission power that is larger than the first transmission power when the amount of the spatial movement is above the threshold.

According to another aspect of the present invention, there is provided a method for performing close proximity wireless communication by a wireless communication device with a counterpart device, the method including: receiving a command signal sent from the counterpart device; detecting an amount of a spatial movement of the wireless communication device when the command signal is received; transmitting a response signal to the counterpart device in response to the command signal in a first transmission power when the amount of the spatial movement is below a threshold; and transmitting the response signal to the counterpart device in response to the command signal in a second transmission power that is larger than the first transmission power when the amount of the spatial movement is above the threshold.

### BRIEF DESCRIPTION OF THE DRAWINGS

A general configuration that implements the various feature of the invention will be described with reference to the drawings. The drawings and the associated descriptions provided to illustrate embodiments of the invention and not to limit the scope of the invention.

FIG. 1 is a view showing the external appearance of a wireless communication device according to an embodiment of the invention.

FIG. 2 is a block diagram of the wireless communication device according to the embodiment of the invention.

FIG. 3 is a flow chart showing an operation concerned with non-contact communication of the wireless communication device according to the embodiment of the invention.

### DETAILED DESCRIPTION OF THE EMBODIMENTS

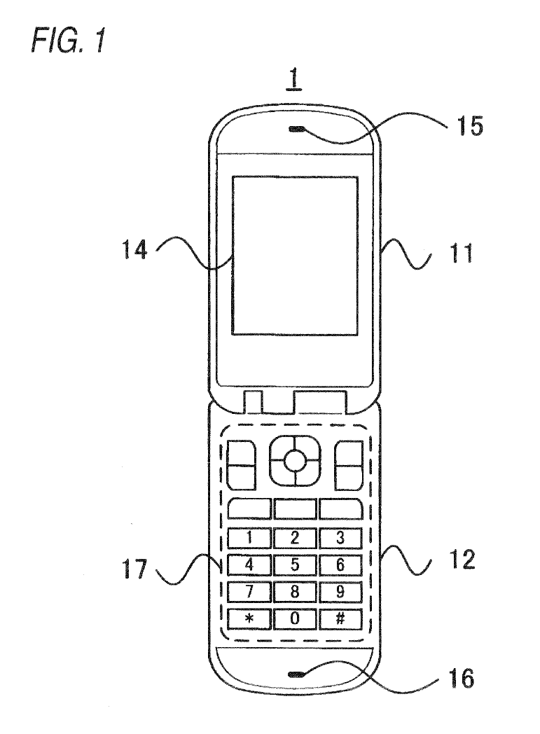

An embodiment of the invention will be described below with reference to FIGS. 1 to 3. The terms “up”, “down”, “left”, “right”, “horizontal” and “vertical (perpendicular)” with reference to the following drawings mean up, down, left, right, horizontal and vertical (perpendicular) shown in the paper of the drawings if there is no special notice. In the following description, the same or similar components will be denoted by the same reference numerals, and the duplicate description thereof will be omitted.

FIG. 1 is a view showing the external appearance of a foldable portable communication terminal 1, which is a wireless communication device according to an embodiment of the invention. The portable communication terminal 1 has a first case 11 and a second case 12 which are connected to each other so that they can be opened and closed to each other. FIG. 1 shows a state where the first case 11 and the second case 12 are opened to each other, in view from a user side. However, the casing configuration of the portable communication terminal 1 is not limited to the foldable type as shown in FIG. 1.

A display device 14, for example, having a liquid crystal display panel, is mounted in the first case 11. The display device 14 is configured to display texts and images, so that the portable communication terminal 1 can run an application (such as a mailer application, a web browser application, and an address book application) with screen display by using the display device 14. A microphone 15 is mounted in the first case 11. A speaker 16 is mounted in the second case 12. The portable communication terminal 1 can be used for voice communication since the microphone 15 and the speaker 16 are provided in the portable communication terminal 1.

A user interface 17 (indicated in FIG. 1 by broken-line frame) including a plurality of operation keys is mounted in the second case 12. The user interface 17 may include operation keys not shown but provided in a side surface or a back surface of the first case 11 or the second case 12. When operation keys belonging to the user interface 17 are operated, start/stop operation of the portable communication terminal 1 or input of texts or operation commands is performed. Each of the display device 14, the microphone 15, the speaker 16 and the user interface 17 serves as a user interface unit in the portable communication terminal 1.

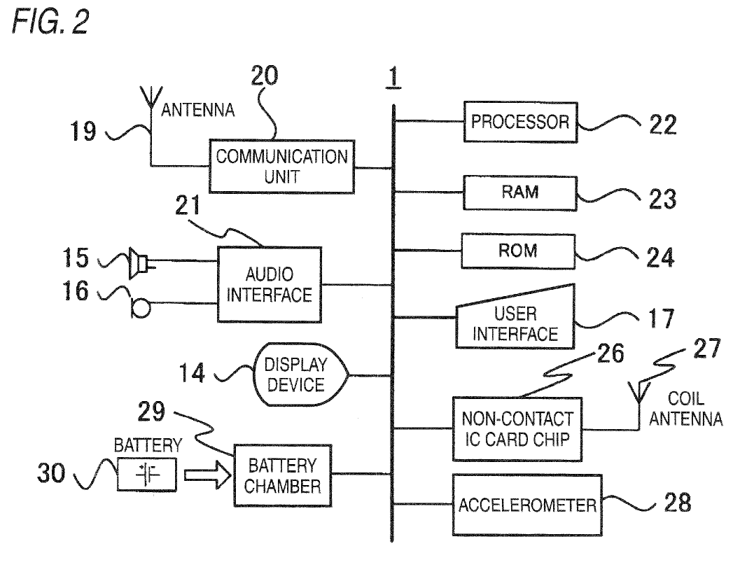

FIG. 2 is a block diagram of the portable communication terminal 1. The portable communication terminal 1 includes an antenna 19 and a communication unit 20, so that the portable communication terminal 1 can transmit/receive radio waves to/from a mobile communication base station not shown. The portable communication terminal 1 further includes an audio interface 21, a processor 22, a random access memory (RAM) and a read-only memory (ROM) 24.

The processor 22 is configured lay a single processing device such as a micro-processor or by a combination of a plurality of such chips. The RAM 23 is a memory used by the processor 22 which reads or writes necessary programs or data at any time to achieve the function of the portable communication terminal 1. The ROM 24 is a memory in which programs or data are written in advance.

The communication unit 20, the audio interface 21, the RAM 23 and the ROM 24 are connected to the processor 22, for example, through a common bus and monitored and controlled by the processor 22. The user interface 17 described above with reference to FIG. 1 is connected to the processor 22, for example, likewise through the common bus so that the user interface 17 can send a signal corresponding to an operation input to the processor 22. The display device 14 described above with reference to FIG. 1 is connected, for example, to the common bus so that the display device 14 can perform screen display under the control of the processor 22. In the portable communication terminal 1, the processor 22 serves as a controller that controls respective components provided in the portable communication terminal 1.

The portable communication terminal 1 further includes a non-contact IC card chip 26, a (coil) antenna 27 having a coil-shaped element, and an accelerometer 28. The portable communication terminal 1 further includes a battery chamber 29, and a battery 30 placed in the battery chamber 29 supplies DC power to respective components of the portable communication terminal 1 including the non-contact IC card chip 26.

When the portable communication terminal 1 is positioned to be close to a reader-writer, which is not shown in the drawings, so that the coil antenna 27 is faced to an antenna of the reader-writer, the reader-writer performs writing or reading of information in/from the non-contact IC card chip 26.

The non-contact IC card chip 26 has built-in transmitter and receiver and is connected to the processor 22, for example, through the common bus. The non-contact IC card chip 26 can notify the processor 22 of reception of a signal which is transmitted from the reader-writer. Since the non-contact IC card chip 26 is supplied with electric power from the battery 30, the non-contact IC card chip 26 is capable of setting transmission power of the transmitter variably in accordance with control made by the processor 22, while a stand-alone non-contact IC card which has no battery and which derives a power from a signal transmitted from the reader-writer.

In the portable communication terminal 1 according to the embodiment, the non-contact IC card chip 26 serves as a close proximity communication unit, configured to perform close proximity wireless communication with the counterpart device.

The accelerometer 28 is manufactured, for example, by using a Micro Electro Mechanical Systems (MEMS) technique and provided for detecting an applied acceleration. The accelerometer 28 is connected to the processor 22, for example, through the common bus so that the processor 22 can determine the portable communication terminal 1 as “moving” from the amount of spatial movement of the portable communication terminal 1 when the output of the accelerometer 28 exceeds a given threshold value.

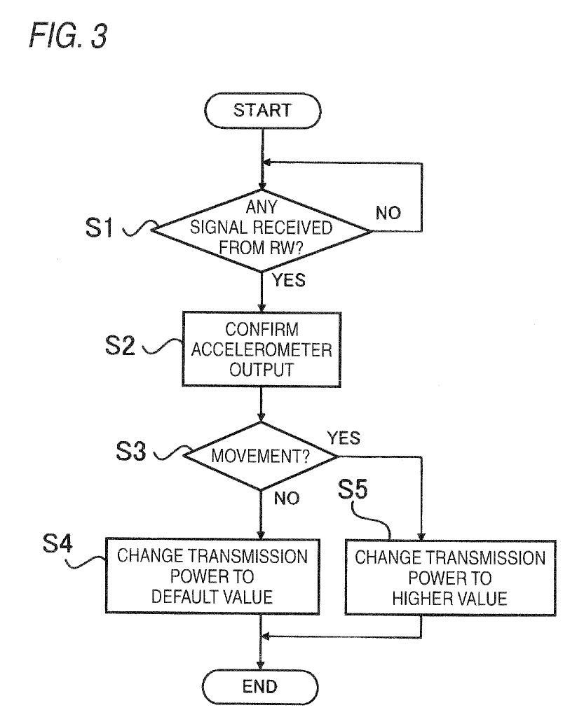

FIG. 3 is a flow chart showing the operation concerned with non-contact communication of the portable communication terminal 1 with the reader-writer. After the operation is started (START), the processor 22 waits for reception of a signal which is transmitted from the reader-writer (“NO” in step S1). When a signal transmitted from the reader-writer is received by the non-contact IC card chip 26 (“YES” in step S1), the processor 22 confirms the output of the accelerometer 28 and compares the output of the accelerometer 28 with the aforementioned threshold value to thereby determine whether the portable communication terminal 1 is moving or not.

When the processor 22 determines that the portable communication terminal 1 is not moving (“NO” in step S3), the processor 22 sets transmission power of the transmitter of the non-contact IC card chip 26 at a default value (step 54) and makes the non-contact IC card chip 26 communicate with the reader-writer. Thus, the operation is terminated (END). When the processor 22 determines that the portable communication terminal 1 is moving (“YES” in step S3), the processor 22 sets transmission power of the transmitter of the non-contact IC card chip 26 at a higher value than a default value (step S5) and makes the non-contact IC card chip 26 communicate with the reader-writer. Thus, the operation is terminated (END).

Since transmission power of the transmitter of the non-contact IC card chip 26 is controlled to be increased when determination is made that the portable communication terminal 1 is moving described above, the portable communication terminal 1 can increase the probability that communication with the reader-writer will be allowed, even if there arises a situation that the portable communication terminal 1 cannot be brought sufficiently close to the reader-writer. Since there is provided a flow in which the processor 22 confirms the output of the accelerometer 28 only when a signal transmitted from the reader-writer is received, it is possible to suppress the possibility that detection of acceleration will be caused by an operation per se of putting the portable communication terminal 1 over the reader-writer although the portable communication terminal 1 is not moving.

Although communication between the portable communication terminal 1 and the reader-writer is based on a near electromagnetic field wireless communication, for example, using a nominal frequency of 13.56 MHz, the communication method is not limited to this method. Any mounting form may be applied to the reader-writer. For example another portable communication terminal having a built-in reader-writer function may be used as the reader-writer.

According to the embodiment of the invention, it is possible to reduce the probability that communication will it fail when the portable communication terminal having the built-in non-contact IC card chip is put over the reader-writer while the portable communication terminal is moving. In the above description, the external appearance, shape, configuration and non-contact communication type of the wireless communication device are only described by way of example and can be changed variously without departing from the gist of the invention.

In the portable communication terminal 1 according to the embodiment, the accelerometer 28 is provided for detecting applied acceleration as an amount of spatial movement of the communication unit 20 (i.e. the portable communication terminal 1). In other words, the accelerometer 28 serves as a detector configured to detect an amount of spatial movement of the communication unit 20. However, the portable communication terminal 1 may alternatively be provided with a proximity sensor configured to detect a variation in positional relationship between the communication unit 20 and the counterpart device as the amount of the spatial movement. The proximity sensor, which may be used as the detector for detecting the amount of the spatial movement, may be any type of sensor such as an inductive sensor, a capacitive sensor, eddy-current sensor, a magnetic sensor, a photoelectric sensor, a laser rangefinder, a sonar, a radar, a thermal infrared sensor, and an optical sensor.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication device comprising:
a close proximity communication unit configured to perform close proximity wireless communication with counterpart device to receive a command signal sent from the counterpart device and to transmit a response signal to the counterpart device in response to the command signal;
a detector configured to detect an amount of a spatial movement of the close proximity communication unit; and
a controller configured to control the detector to detect the amount of the spatial movement when the command signal is received by the close proximity communication unit and control the close proximity communication unit to transmit the response signal in a first transmission power when the amount of the spatial movement is below a threshold and in a second transmission power that is larger than the first transmission power when the amount of the spatial movement is above the threshold.

2. The device of claim 1, wherein the detector is an accelerometer configured to detect applied acceleration as the amount of the spatial movement.

3. The device of claim 1, wherein the detector is a proximity sensor configured to detect a variation in positional relationship between the close proximity communication unit and the counterpart device as the amount of the spatial movement.

4. The device of claim 1, wherein the close proximity communication unit performs a near electromagnetic field wireless communication using electromagnetic induction as the close proximity wireless communication.

5. The device of claim 4, wherein the close proximity communication unit performs the close proximity wireless communication using a nominal frequency of 13.56 MHz.

6. The device of claim 1 further comprising a battery configured to supply power to the close proximity communication unit and the controller.

7. A method for performing close proximity wireless communication by a wireless communication device with a counterpart device, the method comprising:
receiving command signal sent from the counterpart device;
detecting an amount of a spatial movement of the wireless communication device when the command signal is received;
transmitting a response signal to the counterpart device in response to the command signal in a first transmission power when the amount of the spatial movement is below a threshold; and
transmitting the response signal to the counterpart device in response to the command signal in a second transmission power that is larger than the first transmission power when the amount of the spatial movement is above the threshold.
